(19) United States
(12) Patent Application Publication
(10) Pub. No.: US 2008/0186472 A1
(43) Pub. Date: Aug. 7, 2008

(54) APPARATUS AND METHOD FOR INSPECTING A WAFER

(76) Inventors: Jae-Woo Park, Seoul (KR); Chung-Sam Jun, Suwon-si (KR); Jang-Ik Park, Suwon-si (KR); Yu-Sin Yang, Seoul (KR)

Correspondence Address: F. CHAU & ASSOCIATES, LLC, 130 WOODBURY ROAD, WOODBURY, NY, 11797, US

(21) Appl. No.: 12/023,326

(22) Filed: Jan. 31, 2008

(30) Foreign Application Priority Data
Feb. 2, 2007 (KR) 2007-11176

(51) Int. Cl. G01J 3/00; G01N 21/00; G01J 4/00

(52) U.S. Cl. 356/51; 356/237.6; 356/364; 356/300

(57) ABSTRACT

An apparatus for inspecting a wafer includes a light source, a detecting part and a signal analyzing part. The light source emits a light onto the wafer, and the detecting part detects a radiation light emitted from the wafer by the light and generates a signal. The signal analyzing part analyzes the signal generated by the detecting part and determines whether a defect has been formed on the wafer.

### CROSS-REFERENCE TO RELATED APPLICATION

This application claims priority under 35 USC § 119 to Korean Patent Application No. 2007-11176, filed on Feb. 2, 2007 in the Korean Intellectual Property Office (KIPO), the contents of which are herein incorporated by reference in their entirety.

### BACKGROUND OF THE INVENTION

1. Technical Field

Exemplary embodiments of the present invention relate to an apparatus and a method for inspecting a wafer. More particularly, exemplary embodiments of the present invention provide an apparatus and a method for inspecting a wafer by detecting pattern defects in the wafer.

2. Discussion of Related Art

Generally, a semiconductor device is manufactured by repeating a process for forming a plurality of circuit patterns on a wafer using photolithography. When the circuit patterns are formed on the wafer, defects may be generated in the circuit patterns. More specifically, a short between metal conductors, that is, a bridge may be generated because unnecessary portions of the metal conductors are not completely removed during the photolithography process. In order to confirm whether defects are generated or not, a process for inspecting the wafer is performed.

Conventionally, a visible light, an electron beam or a laser beam is emitted onto a wafer on which patterns are formed, and images of the patterns are generated by using light reflected from or scattered at the wafer. Then, images of normal portions of the patterns and images of abnormal portions of the patterns are compared to each other so that pattern defects may be detected. The size of any pattern defect has been reduced accordingly as the sizes of the patterns are reduced, however, and thus detecting the defects by the conventional method has a limitation. That is, the patterns and the defects are nanoscale in size, and thus analyzing images from a reflective light or a scattered light having a wavelength larger than the size of the patterns or the defects may produce inexact results.

### SUMMARY OF THE INVENTION

Exemplary embodiments of the present invention provide an apparatus for inspecting a wafer that is able to detect pattern defects having a nanoscale size on the wafer.

Exemplary embodiments of the present invention provide a method for inspecting a wafer in which pattern defects having a nanoscale size on the wafer may be detected.

According to an exemplary embodiment of the present invention, there is provided an apparatus for inspecting a wafer. The apparatus includes a light source, a detecting part, and a signal analyzing part. The light source emits light onto the wafer. The detecting part detects light radiated back from the wafer and generates a detection signal. The signal analyzing part analyzes the detection signal generated by the detecting part and determines whether a defect has been formed on the wafer.

In an exemplary embodiment of the present invention, the light source may emit a laser beam.

In an exemplary embodiment of the present invention, the light may be emitted onto conductive patterns and a bridge between the conductive patterns on the wafer.

In an exemplary embodiment of the present invention, the apparatus may further include a polarizing filter for polarizing the light emitted from the light source in a direction substantially parallel to a direction in which the bridge is formed on the wafer.

In an exemplary embodiment of the present invention, the light may be emitted onto the wafer in a direction perpendicular to the wafer.

According to an exemplary embodiment of the present invention, the apparatus may further include a light path changer for changing the path of the light emitted from the light source into a direction perpendicular to the wafer.

In an exemplary embodiment of the present invention, the light may be emitted onto the wafer at an acute angle to the wafer.

According to an exemplary embodiment of the present invention, the signal analyzing part may determine whether the defect has been formed on the wafer by comparing signals on at least three adjacent dies generated by the detecting part.

In an exemplary embodiment of the present invention, the signal analyzing part may determine whether the defect has been formed on the wafer by comparing a first image signal on a first cell to a second image signal on a second cell that is disposed at a predetermined distance from the first cell.

In an exemplary embodiment of the present invention, the detecting part may include a charge coupled device (CCD) for generating an image signal of the radiation light emitted from the wafer.

In an exemplary embodiment of the present invention, the signal analyzing part may determine whether the defect has been formed on the wafer when a specific portion of the wafer has a brightness different from the brightnesses of adjacent portions of the wafer by more than a threshold value.

According to an exemplary embodiment of the present invention, the detecting part may further include a grating for splitting the radiation light emitted from the wafer into spectra according to the wavelengths thereof.

In an exemplary embodiment of the present invention, the detecting part may include a grating and a photo-multiplier tube (PMT). The grating may split the radiation light emitted from the wafer into spectra according to wavelengths thereof. The PMT can then generate amplified signals of the spectra.

According to an exemplary embodiment of the present invention, the signal analyzing part may determine whether the defect has been formed on the wafer when the signals amplified by the PMT have a value greater than a threshold value.

In an exemplary embodiment of the present invention, the apparatus may further include a light filter through which an infrared ray passes being disposed between the wafer and the detecting part.

In an exemplary embodiment of the present invention, the radiation light may have a maximum intensity in a wavelength range of about 1 to about 4 μm.

According to an exemplary embodiment of the present invention, there is provided a method for inspecting a wafer. In the inventive method for inspecting a wafer, a light is emitted onto the wafer. A signal is generated by detecting the light radiated back from the wafer. Whether a defect has been formed on the wafer is determined by analyzing the generated detection signal.

In an exemplary embodiment of the present invention, when the light is emitted onto the wafer a laser beam may be used.

According to an exemplary embodiment of the present invention, when the light is emitted onto the wafer, the light may be emitted onto conductive patterns and a bridge between the conductive patterns on the wafer.

In an exemplary embodiment of the present invention, the light emitted from the light source may be polarized in a direction substantially parallel to a direction in which the bridge is formed on the wafer.

According to an exemplary embodiment of the present invention, when the light is emitted onto the wafer, the light may be emitted onto the wafer in a direction perpendicular to the wafer.

In an exemplary embodiment of the present invention, the path of the light emitted from the light source may be changed into the direction perpendicular to the wafer by a light path changer.

In an exemplary embodiment of the present invention, when the light is emitted onto the wafer, the light may be emitted onto the wafer at an acute angle to the wafer.

According to an exemplary embodiment of the present invention, when the generated signal is analyzed, whether the defect has been formed on the wafer may be determined by comparing the generated signals on at least three adjacent dies.

In an exemplary embodiment of the present invention, when the generated signal is analyzed, whether the defect has been formed on the wafer may be determined by comparing a first image signal on a first cell to a second image signal on a second cell that is disposed at a predetermined distance from the first cell.

In an exemplary embodiment of the present invention, when the radiation light emitted from the wafer is detected, an image signal of the radiation light may be generated by a CCD.

In an exemplary embodiment of the present invention, when the generated signal is analyzed, the defect is determined to have been formed on the wafer when a specific portion of the wafer has a brightness different from those of adjacent portions of the wafer by more than a threshold value.

According to an exemplary embodiment of the present invention, when the radiation light emitted from the wafer is detected, the radiation light emitted from the wafer may be split into spectra according to wavelengths thereof by a grating.

According to an exemplary embodiment of the present invention, when the radiation light emitted from the wafer is detected, the radiation light emitted from the wafer may be split into spectra according to wavelengths thereof by a grating. Amplified signals of the spectra may be generated by a PMT.

In an exemplary embodiment of the present invention, when the generated signal is analyzed, the defect is determined to have been formed on the wafer when the amplified signals by the PMT have a value of more than a threshold value.

According to an exemplary embodiment of the present invention, before the radiation light emitted from the wafer is detected, the light radiated onto or reflected by the wafer may be filtered by an infrared ray filter.

In an exemplary embodiment of the present invention, the radiation light may have a maximum intensity in a wavelength range of about 1 to about 4 μm.

According to exemplary embodiments of the present invention, a laser beam is emitted onto a wafer having a pattern and a defect thereon, thereby heating the pattern and the defect. Heat from black body radiation due to temperatures of the pattern and the defect, respectively, are detected by detecting radiation from both the pattern and the defect, respectively, and signals corresponding to the radiation are generated. Whether the defect has been formed on the wafer may be easily determined by analyzing the generated signals.

### BRIEF DESCRIPTION OF THE DRAWINGS

Exemplary embodiments of the present invention will be understood in more detail from the following descriptions taken in conjunction with the accompanying drawings, in which:

FIG. 1A is a cross-sectional view illustrating a wafer having a defect between patterns thereon in order to explain a principle of detecting the defect by analyzing a heat signal from the wafer in an apparatus and a method for inspecting the wafer in accordance with exemplary embodiments of the present invention;

FIG. 1B is a graph showing Planck curves of the patterns having a temperature of about 340 K and the defect having a temperature of about 1,300 K, respectively;

FIG. 2A is a block diagram illustrating an apparatus for inspecting a wafer in accordance with exemplary embodiments of the present invention;

FIG. 2B is a block diagram illustrating an apparatus for inspecting a wafer in accordance with exemplary embodiments of the present invention;

FIG. 3 is a picture of images generated by detecting radiation of a wafer having a defect thereon;

FIG. 4A is a block diagram illustrating a detecting part of an apparatus for inspecting a wafer in accordance with exemplary embodiments of the present invention;

FIG. 4B is a block diagram illustrating a detecting part of an apparatus for inspecting a wafer in accordance with other exemplary embodiments of the present invention; and

FIG. 5 is a flow chart illustrating a method for inspecting a wafer in accordance with exemplary embodiments of the present invention.

### DETAILED DESCRIPTION OF EXEMPLARY EMBODIMENTS

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those of ordinary skill in the art.

Hereinafter, exemplary embodiments of the present invention will be explained in detail with reference to the accompanying drawings.

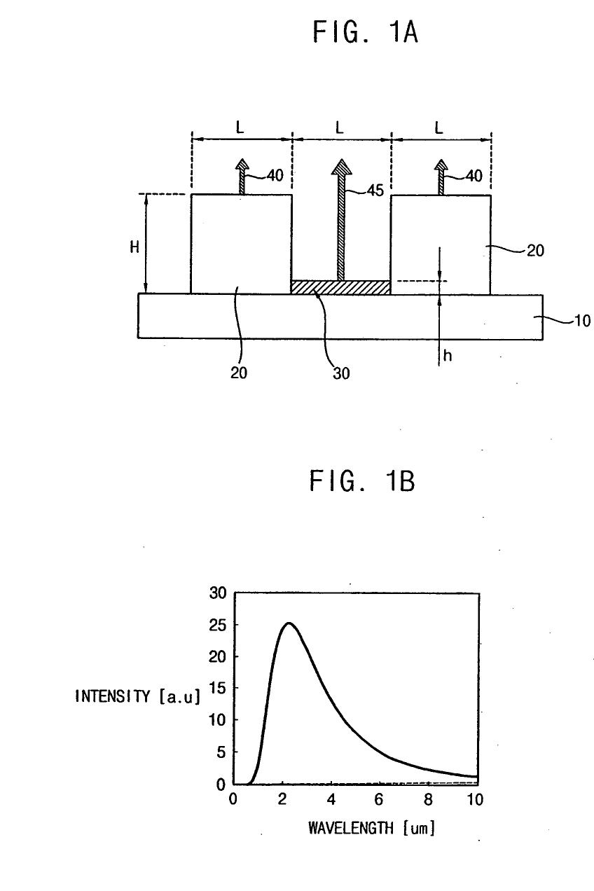

FIG. 1A is a cross-sectional view illustrating a wafer having a defect between patterns thereon for use in explaining a principle of detecting the defect by analyzing a heat signal from the wafer in an apparatus and a method for inspecting the wafer in accordance with exemplary embodiments of the present invention. FIG. 1B is a graph showing Planck curves of the patterns having a temperature of about 340 K and the defect having a temperature of about 1,300 K.

Referring to FIG. 1A, a defect 30 is formed between patterns 20 on a wafer 10. The patterns 20 may include conductive material, and the defect 30 may be a bridge that is a portion of a conductive structure not completely removed when the original conductive structure is partially removed when forming the patterns 20.

When light is radiated from the outside onto the wafer 10 having the patterns 20 and the defect 30 thereon, the energy of the light may be transmitted to the patterns 20 and the defect 30, thereby increasing the respective temperatures of the patterns 20 and the defect 30. More specifically, when the patterns 20 and the defect 30 include conductive material, the light energy is transmitted to electrons included in the conductive material, and the electrons move in the conductive material to generate currents. Accordingly, heat created by electrical resistance in the conductive material may increase the respective temperatures of the patterns 20 and the defect 30.

The light energy transmitted to the electrons, and the electrical energy due to the movements of the electrons, may be represented by the following Equation 1 and Equation 2, respectively.

Eₕₑₐₜ=ΔT·CLA [Equation 1]

Here, “ΔT” indicates an amount of temperature change of the patterns 20 or the defect 30, “C” means a specific heat of the patterns 20 or the defect 30, “L” represents a length of the patterns 20 or the defect 30, and “A” indicates a cross-sectional area of the patterns 20 or the defect 30.

E_{electric}=I²R [Equation 2]

Here, “I” means a current due to the movements of electrons in the patterns 20 or the defect 30, and “R” indicates a resistance of the patterns 20 or the defect 30.

The resistance “R” may be expressed by the following Equation 3.

R=ρ·(L/A) [Equation 3]

Here, “ρ” indicates the specific resistance of the patterns 20 or the defect 30.

If all of the light energy transmitted to the patterns 20 or the defect 30 is converted into electrical energy in the patterns 20 or the defect 30, the following equation may be derived from Equations 1, 2 and 3.

ΔT·A²=(ρ/C)·I²

Thus, the amount of temperature change “ΔT” of the patterns 20 or the defect 30 is inversely proportional to the square of the cross-sectional area “A” thereof. The cross-sectional area “A” is proportional to a height H of the patterns 20 or a height h of the defect 30, and thus the amount of temperature change “ΔT” is inversely proportional to the square of the height H of the patterns 20 or that of the height h of the defect 30. Accordingly, when the patterns 20 and the defect 30 have substantially the same width (not shown), the amount of temperature change “ΔT” of the patterns 20 may be (h/H)² times the amount of temperature change “ΔT” of the defect 30 by assuming that the patterns 20 and the defect 30 include substantially the same material and by assuming substantially the same amount of light is radiated onto the patterns 20 and the defect 30.

For example, when the patterns 20 have a height H of about 50 nm and the defect 30 has a height h of about 10 nm, the amount of temperature change “ΔT” of the defect 30 may be about 5² times the amount of temperature change “ΔT” of the patterns 20 on the above-mentioned assumption.

According to Planck's Law, an absolute temperature of a black body and spectra of radiations from the black body have a relationship expressed as follows in Equation 4.

u(λ,T)(8πhc/λ⁵)/(e^{hc}/λkT−1) [Equation 4]

Here, “λ” is a wavelength, “h” indicates Planck's constant, “c” means the speed of light, “T” represents an absolute temperature, and “k” is Boltzmann's constant.

FIG. 1B shows Planck curves of the patterns 20 and the defect 30, respectively, when both of the patterns 20 and the defect 30 have an initial absolute temperature of about 300 K, and the absolute temperatures are increased by 40 K and 1,000 K, respectively, that is, the patterns 20 come to have an absolute temperature of about 340 K and the defect 30 comes to have an absolute temperature of about 1,300 K. More specifically, the dotted curve represents an intensity of radiations from the patterns 20 and the solid curve represents an intensity of radiations from the defect 30, assuming that both of the patterns 20 and the defect 30 are black bodies.

Referring to FIG. 1B, the intensity of radiation from the patterns 20 has a very small value in a wavelength range of about 1 to about 4 μm, however, the intensity of radiation from the defect 30 has a large value and even a maximum value in that wavelength range. That is, the radiation from the defect 30 having an absolute temperature higher than that of the patterns 20 includes a lot of infrared rays, such as medium infrared rays in the wavelength range.

Referring to FIG. 1A again, the heat from the patterns 20 and the defect 30 due to the movements of the electrons in the conductive material, which may be generated by the energy of the light radiated onto the patterns 20 and the defect 30 from outside, may be emitted outwardly in a type of a first radiation light 40 and a second radiation light 45, respectively. Intensities of the first and second radiation lights 40 and 45 in a specific wavelength range are varied according to the temperatures of the patterns 20 and the defect 30, respectively, which are different from each other according to the height difference or area difference between the patterns 20 and the defect 30. More specifically, the second radiation light 45 from the defect 30 has an intensity much larger than that of the first radiation light 40 from the patterns 20 in a short wavelength range. Thus, whether the defect 30 has been formed on the wafer 10 may be determined by detecting the first and second radiation lights 40 and 45.

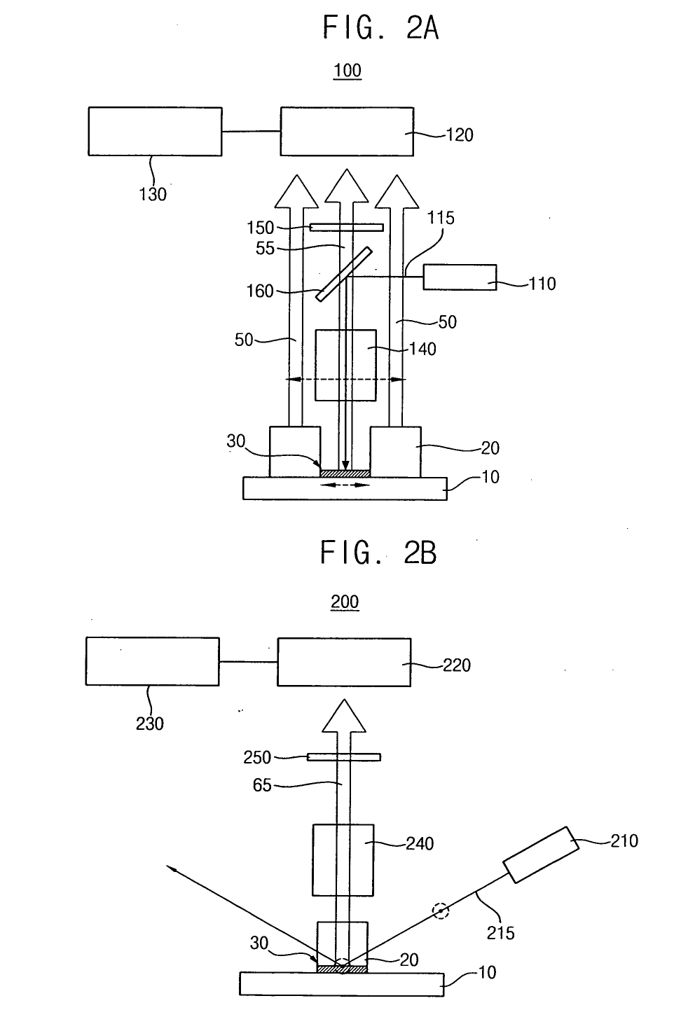

FIGS. 2A and 2B are block diagrams, each illustrating an apparatus for inspecting a wafer in accordance with exemplary embodiments of the present invention.

Referring to FIG. 2A, an apparatus 100 for inspecting a wafer includes a light source 110, a detecting part 120 and a signal analyzing part 130. Additionally, the apparatus 100 may further include a lens 140, a light filter 150 and a light path changer 160.

The light source 110 emits a light 115 onto a wafer 10. The wafer 10 may have an increase in temperature caused by the light 115 emitted from the light source 110. More specifically, the light source 110 may emit the light 115, which could be a visible light, an infrared ray, an ultra-violet ray, or the like, onto the wafer 10. In an exemplary embodiment of the present invention, the light 115 includes a laser beam. The laser beam may include a visible laser beam, an infrared ray beam, an ultra-violet ray beam, or the like.

The light 115 emitted from the light source 110 may be vertically incident on the wafer 10. In an exemplary embodiment of the present invention, the apparatus 100 includes the light path changer 160, which changes the path of the light 115 so that the light 115 may be vertically incident on the wafer 10. The light path changer 160 may include a beam splitter, which reflects or refracts the light 115 so that the light 115 emitted from the light source 110 may be vertically incident on the wafer 10. The wafer 10 can be moved back and forth under the light 115, as represented by the double-headed arrow in FIG. 2B.

The light 115 is radiated onto the wafer 10 having patterns 20 and a defect 30 thereon, and thus the energy of the light 115 may be transmitted to the patterns 20 and the defect 30. Accordingly, each of the patterns 20 and the defect 30 will have an increase in temperature. The patterns 20 include conductive material, and the defect 30 may be a bridge that is a portion of a conductive structure not completely removed when the conductive structure is partially removed to form the patterns 20. Electrons in the conductive material of the patterns 20 and the defect 30 will be caused to move by the light energy, and heat will be generated by the electrical resistance to the movements of the electrons. The heat of the electrical resistance will increase the respective temperatures of the patterns 20 and the defect 30, and thus the patterns 20 and the defect 30 will emit heat by emitting a first radiation light 50 and a second radiation light 55, respectively. In an exemplary embodiment of the present invention, the apparatus 100 may further include a polarizing filter (not shown) polarizing the light 115 in a direction substantially parallel to a direction in which the bridge is formed on the wafer 10. When the light 115 is polarized in the direction substantially parallel to that in which the bridge is formed, currents of the electrons in the bridge that are moved by the light energy may be generated more efficiently.

The detecting part 120 detects the first and second radiation lights 50 and 55, which correspond to the radiation lights 40 and 45, respectively, as shown in FIG. 1A. The detecting part 120 may include a charge coupled device (CCD) or a photo-multiplier tube (PMT).

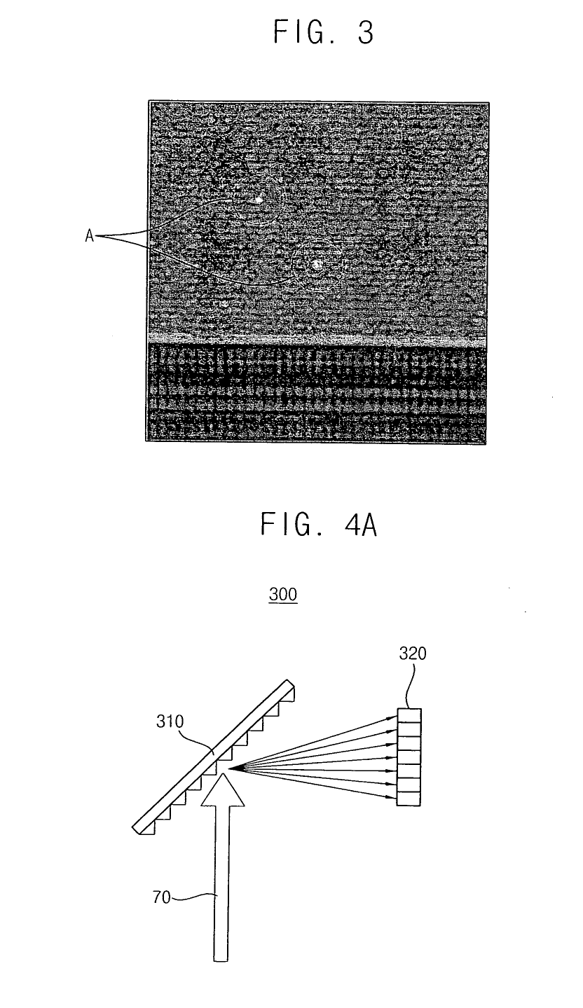

When the detecting part 120 includes a CCD, the CCD can detect the first and second radiation lights 50 and 55, and convert the first and second radiation lights 50 and 55 into image signals. In FIG. 3, images generated by detecting radiation lights of the wafer 10 having the defect 30 are shown.

Referring to FIG. 3, areas A have an image much brighter than the areas peripheral to areas A, which means that the radiation light emitted from the areas A has an intensity much larger than the intensities from the peripheral areas. That is, the areas A may be presumed to have the defect 30 because the areas A have a temperature much higher than the temperatures of the peripheral areas.

The detecting part 120 may further include gratings that divide the first and second radiation lights 50 and 55 according to wavelengths thereof and transmit the divided first and second radiation lights 50 and 55 to the CCD, which is illustrated with reference to FIG. 4A.

FIG. 4A is a block diagram illustrating a detecting part of an apparatus for inspecting a wafer in accordance with an exemplary embodiment of the present invention.

Referring to FIG. 4A, a detecting part 300 includes a grating 310 and a CCD 320.

The grating 310 may have a prism shape dividing a radiation light 70 emitted from the patterns 20 or the defect 30 into a various colors according to wavelengths thereof. Thus, the radiation light 70 may be split into spectra thereof and transmitted to the CCD 320.

The radiation light 70 split into the spectra by the grating 310 is transmitted to the CCD 320, so that the defect 30 may be detected by confirming whether a radiation light is generated in a specific wavelength range.

Additionally, an area in which the defect 30 is generated may be more precisely reckoned by amplifying signals of the radiation light 70 in a specific wavelength range, which is illustrated with reference to FIG. 4B.

FIG. 4B is a block diagram illustrating a detecting part of an apparatus for inspecting a wafer in accordance with an exemplary embodiment of the present invention.

Referring to FIG. 4B, a detecting part 400 includes a grating 410 and a PMT 420.

The PMT 420 amplifies a specific spectrum of the radiation light 70 that is split into its spectra according to wavelengths by the grating 410, so that the signal analyzing part 130 may more exactly analyze signals in a desired spectrum.

Referring to FIG. 2A again, the signal analyzing part 130 receives signals from the detecting part 120, and determines whether the defect 30 is present on the wafer 10.

In an exemplary embodiment of the present invention, the signal analyzing part 130 compares signals on dies adjacent each other that have been generated from the detecting part 120, and determines whether the defect 30 is present on the wafer 10. For example, the signal analyzing part 130 may compare signals on at least three adjacent dies other, and determine whether the defect 30 is formed on the wafer 10 when one signal is different from the others.

In an exemplary embodiment of the present invention, the signal analyzing part 130 compares an image signal on a specific cell to an image signal on another cell that is disposed at a predetermined distance from the specific cell in one of a right direction, a left direction, an up direction, or a down direction in a die, and determines whether the defect 30 is formed on the wafer 10. When a difference between the image signal of the specific cell and that of another cell at the predetermined distance in the die is found, the defect 30 may be possibly present on the die, because substantially the same circuit patterns are formed in each cell.

In an exemplary embodiment of the present invention, the signal analyzing part 130 compares an image signal on a portion of a cell or a die to image signals on other portions of the cell or the die, and determines whether the defect 30 is present on the portion of the cell or the die when the image signal of the portion is much different from those of other portions. For example, when a CCD detects the first and second radiation lights 50 and 55 and generates image signals, the defect 30 may be possibly present in a specific portion of a cell or a die by assuming that the specific portion has a brightness different from those of adjacent portions by more than a threshold value.

The apparatus 100 shown in FIG. 2A may further include the lens 140 that enlarges a spatial distribution of the first and second radiation lights 50 and 55, and thus images generated by the detecting part 120 including a CCD may be enlarged.

Additionally, the apparatus 100 may further include the light filter 150 filtering some portions of the light incident on the detecting part 120. In an exemplary embodiment of the present invention, an infrared ray filter through which only an infrared ray can pass serves as the light filter 150. In this exemplary embodiment, when the light 115 is radiated onto or reflected by the wafer 10 in which the energy applied to the patterns 20 and the defect 30 includes visible light or an ultra-violet ray, the visible light or the ultra-violet ray in the light 115 may be filtered out so as not to be incident on the detecting part 120, so that detecting the first and second radiation lights 50 and 55 by the detecting part 120 may be more efficiently performed.

Referring now to FIG. 2B, an exemplary embodiment of an apparatus 200 for inspecting a wafer includes a light source 210, a detecting part 220, and a signal analyzing part 230. Additionally, the apparatus 200 may further include a lens 240 and a light filter 250.

The apparatus 200 may be substantially the same as or similar to the apparatus 100 in FIG. 2A except that an incident angle of light 215 emitted from the light source 210 onto the wafer 10 is different from that of the light 115 emitted from the light source 110 onto the wafer 10.

The light 215 is not necessarily vertically incident on the wafer 10, that is, the light 215 may be incident on the wafer 10 at a selected angle. Thus, the apparatus 200 does not have the light path changer 160 that is included in the apparatus 100 shown in FIG. 2A. Additionally, because the possibility that the light 215 emitted from the light source 210 onto the wafer 10 is directly incident on the detecting part 220 is so low, the light filter 250 is not necessary.

In FIG. 2B, although the defect 30 is shown it would actually be hidden by the patterns 20 but is shown nonetheless in order to clearly show a path of the light 215. That is, if FIG. 2A is referred to as a front view of the wafer 10 having the patterns 20 and the defect 30 thereon, then FIG. 2B may be referred to as a side view thereof.

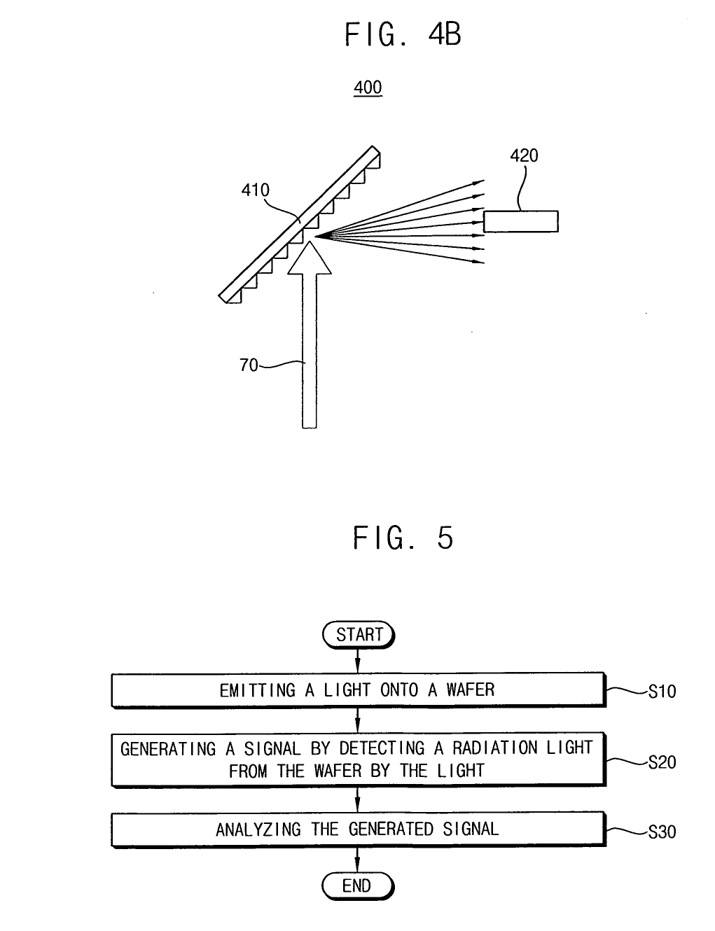

FIG. 5 is a flow chart illustrating a method for inspecting a wafer in accordance with an exemplary embodiment of the present invention.

Referring to FIG. 5, in step S10, a light is emitted onto a wafer having a pattern and a possible defect thereon. Thus, if a defect is present the wafer may have an increased temperature. More specifically, a visible light, an infrared ray, an ultra-violet ray, or the like, may be radiated onto the wafer. In an exemplary embodiment of the present invention, a laser beam is emitted and radiated onto the wafer. The laser beam may include a visible light laser beam, an infrared ray laser beam, an ultra-violet ray laser beam, or the like.

In an exemplary embodiment of the present invention, the light is vertically incident on the wafer. A light path changer that changes the path of the light may be used, so that the light emitted from a light source may be reflected or refracted by the light path changer. For example, a beam splitter may serve as the light path changer.

The light is emitted and radiated onto the wafer so that the energy of the light may be transmitted to the pattern and the possible defect. The pattern can include conductive material, and the defect may be a bridge that is a portion of a conductive structure that was not completely removed when the conductive structure was partially removed to form the pattern. Electrons in the conductive material are caused to move by the light energy, and heat will be generated due to the electrical resistance of the conductive material. The heat caused by the resistance increases the temperatures of the pattern and the defect, and thus the pattern and the defect emit radiation heats in the form of a first radiation light and a second radiation light, respectively. In an exemplary embodiment of the present invention, a polarizing filter may be used so that the light emitted from a light source may be polarized in a direction substantially parallel to a direction in which the bridge is formed on the wafer. When the light is polarized in the direction substantially parallel to that in which the bridge is formed, currents caused by the electrons in the bridge that are moved by the light energy may be generated more efficiently.

In an exemplary embodiment of the present invention, a lens may enlarge a spatial distribution of the first and second radiation lights, and thus images of the radiation lights may be enlarged when the images are generated by a CCD.

In an exemplary embodiment of the present invention, a light filter may filter some portions of the first and second radiation lights that might be incident on the detecting part. An infrared ray filter through which only an infrared ray may pass may serve as the light filter. When the light emitted from the light source onto the wafer (and reflected by the wafer) of which energy is applied to the pattern and the defect includes a visible light or an ultra-violet ray, the visible light or the ultra-violet ray in the light may be filtered out so as not to be incident on the detecting part. In this way, detection of the first and second radiation lights by the detecting part may be more efficiently performed.

In an exemplary embodiment of the present invention, the emitted light is not necessarily vertically incident on the wafer, that is, the light may be incident on the wafer at an arbitrary angle. In this case, the light path changer for changing the path of the light into a direction perpendicular to the wafer would not be necessary. Additionally, the possibility that the light emitted from the light source onto the wafer is directly incident on the detecting part is decreased when the first and second radiation lights are detected, which is different from the case in which the light is vertically incident on the wafer. Thus, the necessity that the light emitted from the light source onto the wafer is filtered so as not to be incident on the detecting part is decreased.

In step S20, the first and second radiation lights are detected, and the appropriate signals are generated. The detecting part may include a CCD or a PMT.

When the CCD is used for detecting the first and second radiation lights, the CCD may generate image signals. When a specific image signal is much brighter than other image signals, a portion corresponding to the specific image signal may emit a radiation light having an intensity much higher than those of other portions. Thus, the brighter specific portion may be presumed to have a temperature much higher than those of the other portions and, thus, represent a defect.

In an exemplary embodiment of the present invention, the detecting part may further include a grating that divides the radiation lights emitted from the patterns or the defect according to wavelengths thereof and transmits the divided radiation lights to the CCD.

The grating may have a prism shape, and divide the radiation lights emitted from the patterns or the defect into a various colors according to the wavelengths thereof. Thus, the radiation lights may be split into spectra thereof and transmitted to the CCD.

The radiation lights split into the spectra by the grating are transmitted to the CCD, so that the defect may be detected by confirming whether a radiation light is generated in a specific wavelength range.

In an exemplary embodiment of the present invention, the detecting part may further include a PMT. Thus, in a successive process for analyzing signals, signals in a desired spectrum may be more exactly analyzed by amplifying a specific portion of the spectrum of the radiation lights that has been split into the spectra according to the wavelengths by the grating.

In step S30, a signal analyzing part analyzes the signals generated by the detecting step S20, and it is determined whether a defect has been formed on the wafer.

In an exemplary embodiment of the present invention, the signal analyzing part compares signals on adjacent dies to each other, where the signals have been generated from the detecting part, and determines whether the defect has been formed on the wafer. For example, the signal analyzing part may compare signals on at least three adjacent dies, and determine whether the defect has been formed on the wafer when one signal is different from the others.

In an exemplary embodiment of the present invention, the signal analyzing part compares an image signal on a specific cell to an image signal on another cell that is disposed at a predetermined distance from the specific cell in one of a right direction, a left direction, an up direction, or a down direction in a die, and determines whether the defect has been formed on the wafer. When a difference between the image signal of the specific cell and that of another cell at the predetermined distance in the die is found, the defect may be possibly formed on the die, because substantially the same circuit patterns are formed in each of the cell.

In an exemplary embodiment of the present invention, the signal analyzing part compares an image signal on a portion of a cell or a die to image signals on other portions of the cell or the die, and determines whether the defect has been formed on the portion of the cell or the die, when the image signal of the portion is much different from those of other portions. For example, when a CCD detects the radiation lights and generates image signals, the defect may possibly be formed in a specific portion of a cell or a die by assuming that the specific portion has a brightness different from those of adjacent portions by more than a threshold value.

According to exemplary embodiments of the present invention, a laser beam is emitted onto a wafer having a pattern and a possible defect thereon, thereby heating the pattern and the defect. Black body radiations due to temperatures of the pattern and the defect, respectively, are detected by detecting radiation lights from the pattern and the defect, respectively, and signals corresponding to the radiation lights are generated. Whether the defect has been formed on the wafer may be easily determined by analyzing the generated signals.

The foregoing is illustrative of the present invention and is not to be construed as limiting thereof. Although exemplary embodiments of the present invention have been described, those of ordinary skill in the art will readily appreciate that many modifications are possible in the exemplary embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. An apparatus for inspecting a wafer, the apparatus comprising:
a light source emitting a light onto the wafer;
a detecting part detecting a radiation light emitted from the wafer caused by the light and generating a detection signal;
a signal analyzing part analyzing the detection signal generated by the detecting part and determining whether a defect has been formed on the wafer.

2. The apparatus of claim 1, wherein the light source emits a laser beam onto the wafer.

3. The apparatus of claim 1, wherein the light is emitted onto conductive patterns and a bridge between the conductive patterns formed on the wafer.

4. The apparatus of claim 3, further comprising a polarizing filter for polarizing the light emitted from the light source in a direction substantially parallel to a direction in which the bridge is formed on the wafer.

5. The apparatus of claim 1, wherein the light is emitted onto the wafer in a direction perpendicular to a flat surface of the wafer.

6. The apparatus of claim 5, further comprising a light path changer for changing a path of the light emitted from the light source into the direction perpendicular to the wafer.

7. The apparatus of claim 1, wherein the light is emitted onto the wafer at an acute angle to a flat surface of the wafer.

8. The apparatus of claim 1, wherein the signal analyzing part determines whether the defect has been formed on the wafer by comparing detection signals generated by the detecting part from at least three adjacent dies.

9. The apparatus of claim 1, wherein the signal analyzing part determines whether the defect has been formed on the wafer by comparing a first image signal on a first cell to a second image signal on a second cell that is disposed at a predetermined distance from the first cell.

10. The apparatus of claim 1, wherein the detecting part comprises a charge coupled device (CCD) for generating an image signal of the radiation light emitted from the wafer.

11. The apparatus of claim 10, wherein the signal analyzing part determines whether the defect has been formed on the wafer when a specific portion of the wafer has a brightness different from respective brightnesses of adjacent portions of the wafer by more than a threshold value.

12. The apparatus of claim 10, wherein the detecting part further comprises a grating for splitting the radiation light emitted from the wafer into spectra according to wavelengths thereof.

13. The apparatus of claim 1, wherein the detecting part comprises:
a grating for splitting the radiation light emitted from the wafer into spectra according to wavelengths thereof; and
a photo-multiplier tube (PMT) for generating amplified signals of the spectra.

14. The apparatus of claim 13, wherein the signal analyzing part determines whether the defect has been formed on the wafer when the amplified signals from the PMT have a value of more than a threshold value.

15. The apparatus of claim 1, further comprising a light filter through which an infrared ray passes, the light filter being disposed between the wafer and the detecting part.

16. The apparatus of claim 1, wherein the radiation light has a maximum intensity in a wavelength range of about 1 to about 4 μm.

17. A method for inspecting a wafer, the method comprising:
emitting a light onto the wafer;
generating a detection signal by detecting a radiation light emitted from the wafer by the light;
determining whether a defect has been formed on the wafer by analyzing the generated detection signal.

18. The method of claim 17, wherein emitting the light onto the wafer comprises emitting a laser beam onto the wafer.

19. The method of claim 17, wherein emitting the light onto the wafer comprises emitting the light onto conductive patterns and a bridge between the conductive patterns formed on the wafer.

20. The method of claim 19, further comprising polarizing the light emitted onto the wafer in a direction substantially parallel to a direction in which the bridge is formed on the wafer.

21. The method of claim 17, wherein emitting the light onto the wafer comprises emitting the light onto the wafer in a direction perpendicular to the wafer.

22. The method of claim 21, further comprising changing a path of the light emitted onto the wafer into the direction perpendicular to the wafer by a light path changer.

23. The method of claim 1, wherein emitting the light onto the wafer comprises emitting the light onto the wafer at an acute angle to the wafer.

24. The method of claim 17, wherein analyzing the generated detection signal comprises determining whether the defect has been formed on the wafer by comparing the generated detection signals on at least three adjacent dies.

25. The method of claim 1, wherein analyzing the generated signal comprises determining whether the defect has been formed on the wafer by comparing a first image signal on a first cell to a second image signal on a second cell that is disposed at a predetermined distance from the first cell.

26. The method of claim 17, wherein detecting the radiation light emitted from the wafer comprises generating an image signal of the radiation light by a CCD.

27. The method of claim 26, wherein analyzing the generated signal comprises determining whether the defect has been formed on the wafer when a specific portion of the wafer has a brightness different from respective brightnesses of adjacent portions of the wafer by more than a threshold value.

28. The method of claim 26, wherein detecting the radiation light emitted from the wafer further comprises splitting the radiation light emitted from the wafer into spectra according to wavelengths thereof by a grating.

29. The method of claim 17, wherein detecting the radiation light emitted from the wafer comprises:
splitting the radiation light emitted from the wafer into spectra according to wavelengths thereof by a grating; and
generating amplified signals of the spectra by a PMT.

30. The method of claim 29, wherein determining whether a defect has been formed on the wafer by analyzing the generated signal comprises determining whether the defect has been formed on the wafer when the amplified signals by the PMT have a value of more than a threshold value.

31. The method of claim 17, prior to detecting the radiation light emitted from the wafer, further comprises filtering the light emitted onto or emitted from the wafer from the radiation light by an infrared ray filter.

32. The method of claim 17, wherein the radiation light has a maximum intensity in a wavelength range of about 1 to about 4 μm.
